(19) United States
(12) Patent Application Publication
(10) Pub. No.: US 2022/0298917 A1
(43) Pub. Date: Sep. 22, 2022

(54) METHOD AND SYSTEM FOR USING VIRTUAL SENSOR TO EVALUATE CHANGES IN THE FORMATION AND PERFORM MONITORING OF PHYSICAL SENSORS

(71) Applicant: LANDMARK GRAPHICS CORPORATION, Houston, TX (US)

(72) Inventors: Travis St. George RAMSAY, Hockley, TX (US); Egidio MAROTTA, Houston, TX (US); Srinath MADASU, Houston, TX (US)

(73) Assignee: LANDMARK GRAPHICS CORPORATION, Houston, TX (US)

(21) Appl. No.: 17/612,363

(22) PCT Filed: Jul. 18, 2019
(86) PCT No.: PCT/US2019/042435

§ 371 Date: Nov. 18, 2021

(51) Int. Cl. E21B 49/00; E21B 47/07; E21B 47/12; G01V 99/00

(52) U.S. Cl. CPC E21B 49/00; E21B 47/07; E21B 47/12; G01V 99/005; E21B 2200/20

(57) ABSTRACT

The present disclosure is related to improvements in methods for evaluating formation fluid properties of interest in an in-production wellbore as well as evaluating health and functionalities of physical sensors present in and collecting data within the well. In one aspect, a method includes receiving data from one or more physical sensors within a wellbore; determining at least one formation property of the wellbore using one or more machine learning models receiving the data as input and generating reservoir simulation models using the at least one formation property.

### TECHNICAL FIELD

The present technology pertains to improvements in methods for evaluating formation fluid properties of interest in an in-production wellbore as well as evaluating health, functionalities and predictive maintenance of physical sensors present in and collecting data within the wellbore.

### BACKGROUND

During various phases of natural resource exploration and production, it may be necessary to characterize and model a target reservoir to determine availability and potential of natural resources production in the target reservoir. Understanding petrophysical properties of the target reservoir such as gamma ray, porosity, absolute permeability, relative permeability and capillary pressure play an important role in reservoir simulation. Currently utilized methods of understanding such petrophysical and hydraulic properties include physical experiments in a laboratory setting where samples of rocks subsurface formations are extracted from a wellbore and analyzed for underlying mineralogical, pore size and pore throat distribution characteristics using CT scanners, analysis, etc. These methods often require new and customized physical sensors to be installed within a wellbore without which anticipating/forecasting changes in physical properties for consideration within the reservoir simulation is not possible on finer length scales. Installing such customized sensors is challenging due to limitation of space within such wellbores. Further, forecasting and planning of maintenance of existing sensors in a wellbore is limited to a priori scheduling or esoteric assumptions.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a schematic diagram of a tubular string provided in a wellbore;

FIG. 2 is a schematic cross-sectional view of an example tubular string having a sensor nipple and corresponding port according to the disclosure herein;

FIG. 3 is a schematic cross-sectional view of another example of a tubular string having a sensor nipple coupled via an connector or fitting according to the disclosure herein;

FIG. 4 is an example method of determining formation properties and maintenance of physical sensor using a virtual sensor, according to one aspect of the present disclosure; and

FIGS. 5A-B illustrate schematic diagram of example computing device and system according to one aspect of the present disclosure.

### DETAILED DESCRIPTION

Various example embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

It will be appreciated that for simplicity and clarity of illustration, where appropriate, reference numerals have been repeated among the different figures to indicate corresponding or analogous elements. In addition, numerous specific details are set forth in order to provide a thorough understanding of the example embodiments described herein. However, it will be understood by those of ordinary skill in the art that the example embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the example embodiments described herein.

The present technology pertains to improvements in methods for evaluating formation fluid properties of interest in an in-production wellbore as well as evaluating health, functionalities and performing predictive maintenance of physical sensors present in and collecting data within the wellbore. As noted above, currently utilized lab setting/digital experiments for understanding such petrophysical properties neither enable anticipating/forecasting changes in physical properties for consideration within the reservoir simulation is not possible nor enable forecasting and planning of maintenance of existing sensors in a wellbore. Hereinafter, methods for using a virtual sensor and machine learning based techniques to (1) determine/forecast changes in formation and petrophysical properties of wellbore and (2) determine/forecast need for maintenance of physical sensors will be described.

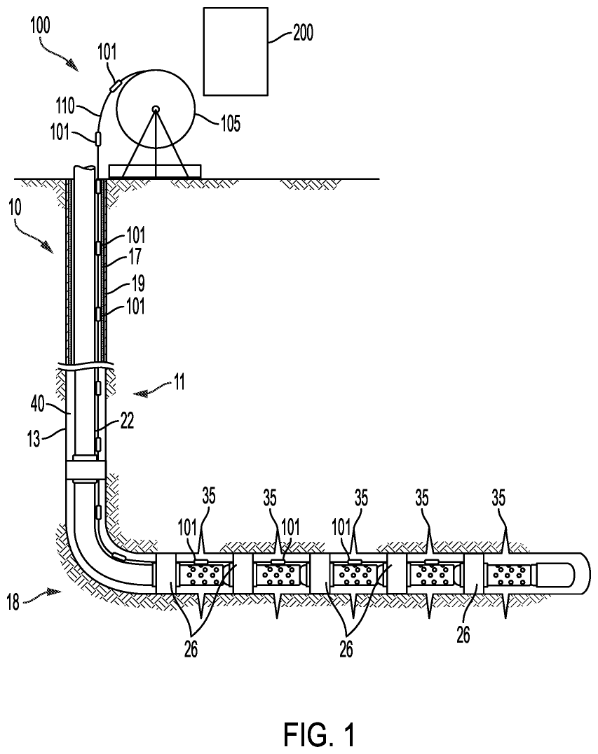

FIG. 1 is a schematic diagram depicting an environment in which the present disclosure may be implemented. As illustrated, the environment includes a producing wellsite 10. With respect to the example embodiment shown in FIG. 1, the producing wellsite 10 includes a tubular string 22 for use in completion and stimulation of formation, and an annulus 40. The terms stimulation and injection, as used herein, can include fracking, acidizing, hydraulic work, and other work-overs. The tubular string 22 may be made up of a number of individual tubulars, also referred to as sections or joints. The sections can include multiple such assemblies as well as blank tubing, perforated tubing, shrouds, joints, or any other sections as are known in the industry. Each of the tubulars of the tubular string 22 may have a central flow passage an internal fluid and an external surface. The term “tubular” may be defined as one or more types of connected tubulars as known in the art, and can include, but is not limited to, drill pipe, landing string, tubing, production tubing, jointed tubing, coiled tubing, casings, liners, or tools with a flow passage or other tubular structure, combinations thereof, or the like.

A wellbore 13 extends through various earth strata. Wellbore 13 has a substantially vertical section 11, the upper portion of which has installed therein casing 17 held in place by cement 19. Wellbore 13 also has a substantially deviated section 18, shown as substantially horizontal, extending through a hydrocarbon bearing portion of a subterranean formation 20. As illustrated, substantially horizontal section 18 of wellbore 13 is open hole, such that there is not a casing. It is understood that within the present disclosure, the wellbore may be cased or open, vertical, horizontal, or deviated, or any other orientation.

Packers 26 straddle target zones of the formation. The packers 26 can isolate the target zones for stimulation and production and which may have fractures 35. The packers 26 may be swellable packers. The packers 26 can also be other types of packers as are known in the industry, for example, slip-type, expandable or inflatable packers. Additional downhole tools or devices may also be included on the work string, such as valve assemblies, for example safety valves, inflow control devices, check valves, etc., as are known in the art. The tubing sections between the packers 26 may include sand screens to prevent the intake of particulate from the formation as hydrocarbons are withdrawn. Various suitable sand screens include wire mesh, wire wrap screens, perforated or slotted pipe, perforated shrouds, porous metal membranes, or other screens which permit the flow of desirable fluids such as hydrocarbons and filter out and prevent entry of undesirable particulates such as sand.

As shown, an array of sensors 100 can be spoolable from spool 105. The array of sensors 100 is shown as having a line 110 which connect each of the individual sensors 101. The plurality of sensors 101 are disposed along the longitudinal length of the tubular string 22 in the wellbore 13. While illustrated as connected by line 110, the array of sensors 100 can also be coupled with the tubular string 22 without the line 110. Data from the array of sensors 101 may be transmitted along the line 110 and provided to one or more processors at the surface, such as device (processing unit) 200 discussed further below. In other examples, data from the array of sensors 101 can be transmitted wirelessly or through the tubular string 22 to surface and/or device 200. Sensors 101 can be any one or more of a pressure sensor, a temperature sensor and/or rate sensor for measuring rate of fluid production in wellbore 13.

The line 110 may be a cord, line, metal, tubing encased conductor (TEC), fiber optic, or other material or construction, and may be conductive and permit power and data to transfer over the line 110 between each of the sensors 101 and to the surface. The line 110 may be sufficiently ductile to permit spooling and some amount of bending, but also sufficiently rigid to hold a particular shape in the absence of external force.

A producing wellsite can be divided into production zones through the use of one or more packers 26. The production flow comes from the formation and may pass through a screen, through a flow regulator (inflow control device (ICD), autonomous inflow control device (AICD), inflow control valve (ICV), choke, nozzle, baffle, restrictor, tube, valve, et cetera), and into the interior of the tubing.

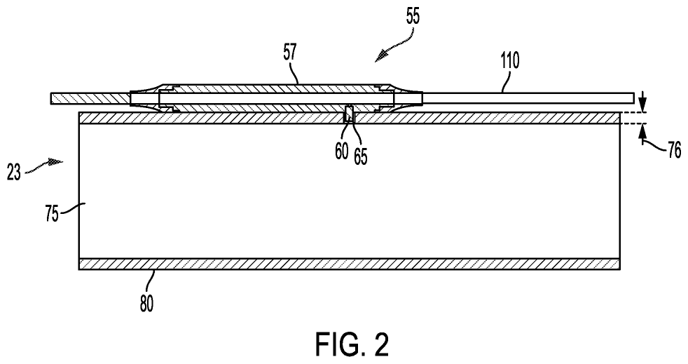

FIG. 2 is a cross-sectional view of a tubular 23 of a tubular string 22 according to the present disclosure. The tubular string 22 can be made from one or more tubulars 23 coupled together forming a length of tubular string. The tubular 23 and tubular string 22 can have a central flow passage 75 formed therethrough. The tubular 23 can be coupled with one or more sensors from the array of sensors 100. A sensor 55 can be one sensor coupled with the senor array 100 of FIG. 1. The sensor 55 can be coupled with a nipple 60 inserted and received into sensor port 65 of the tubular 23.

The sensor 55 may be coupled with the line 110 which connects to other sensors in an array of sensors, such as array of sensors 100, in which the other sensors may be one or more sensors 55, other sensors, or any combination thereof. As shown the tubular 23 has a central flow passage 75 for flow of a fluid (such as, hydrocarbons, etc.) and an external surface 80. In order to monitor fluid properties (such as, temperature and pressure, etc.) within the tubular string 22 a nipple 60 can be coupled to each tubing sensor 55 within the array. The sensor 55 may have a main body 57 and have the nipple 60 extending therefrom. The nipple 60 may be elastomeric, plastic or metal. The nipple 60 can be welded or otherwise coupled with the sensor 55 depending on the arrangement of the nipple 60 and the engagement between the nipple 60 and the tubular 23. In at least one example, the nipple 60 and the tubular 23 can be a metal-to-metal engagement. In particular, the nipple 60 engages the tubular 23 via a corresponding sensor port 65 of tubular 23. The nipple 60 may be an extension or projection and shaped for entry into or otherwise coupling with the sensor port 65.

The sensor port 65, which may be a hole, aperture, notch, groove, indentation, or similar, can be created at any location on the tubing string, such as any location on any particular tubular 23 within the tubular string 22. The sensor port 65 may be made within an approximate location of the sensor 55 or any position or location where the sensor 55 may be. The sensor port 65 may be created by any method available (e.g. drilling, piercing, burning, pierce with attached nipple, etc.). In at least one example, the sensor port 65 can be created on-the-fly, such that a workman on-site can simply form the sensor port 65 and couple the sensor therein by insertion of the nipple 60 into the sensor port 65. The nipple 60 can be self-tapping arrangement for simultaneous formation of the sensor port 65 and coupling of the nipple 60 with the tubular 23. In other examples, the sensor port 65 can be a threaded aperture allowing threaded engagement between the sensor 55 and the tubular 23.

The sensor port 65 can extend from the external surface 80 toward the central flow passage 75 through a wall thickness 76 of the tubular 23. The sensor port 65 can extend through the wall thickness 76 sufficient for the sensor 55 and nipple 60 to measure one or more fluid properties of the fluid within the central flow passage 75. The sensor port 65 can extend through the wall thickness 76 sufficient for the nipple 60 to be in fluidic contact with the central flow passage 75, thus allowing one or more fluid property measurements.

The nipple 60 on the sensor 55 may be positioned inside the sensor port 65 and sealed by an elastomer, metal-to-metal, adhesive seal, or other sealing mechanism. The nipple 60 itself may provide a sealing. In at least one instance, the nipple 60 can be formed from an elastomeric element providing a seal upon coupling the nipple 60 with the sensor port 65. The sealing mechanism provided by between the nipple 60 and the sensor port 65 can prevent annulus fluid from entering the sensor port 65 and/or prevent fluid from exiting the central flow passage 75 and entering the annulus depending on the arrangement of the sensor port 65. In instances where the sensor port 65 extends through the wall thickness 76 of the tubular 23, the sealing mechanism can prevent fluid flow between the central flow passage 75 and annulus. In instances where the sensor port 65 extends through only a portion of the wall thickness 76, the sealing mechanism prevents fluid flow from the annulus into the sensor port 65.

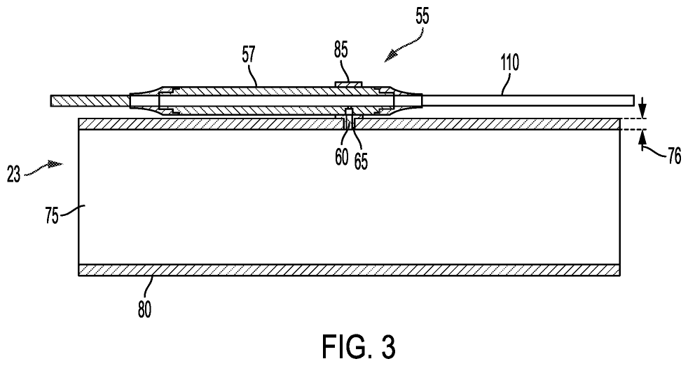

As illustrated in FIG. 3, a connector or fitting 85 may also be used for coupling the nipple 60 with the sensor port 65 of the tubular 23. In at least one instance, the connector or fitting 85 can be a clamp attached to securely hold the sensor 55, thereby reducing movement of the sensor 55 and nipple 60 relative to the tubular 23. The connector or fitting 85 can circumferentially extend around the tubular 23 to compress and/or secure the sensor 55 with the tubular 23. In some instances, alignment tolerances can be adjusted by including a full or semi-coil of the line 110 within the array providing slack and or reducing tension within line 110.

The array of sensors 100 disclosed herein can include sensors having the nipple, as disclosed in FIGS. 2-3, and conventional sensors without the nipple intermixed and coupled with the line 110. In at least one instance, the array of sensors 100 can alternate between sensors having a nipple and convention sensors. In other instances, the array of sensors 100 can have a predetermined ratio of sensors having a nipple to conventional sensors. The ratio of sensors can be distributed in a pattern, such as two convention sensors followed by one sensor with a nipple, and repeated along the length of the line 110. The ratio of sensors can also be distributed substantially randomly along the length of the line 110. While a predetermined ratio of two to one is described above, it is within the scope of this disclosure to have any ratio including, but not limited to, one to one, three to one, three to two, or any other combination, and the ratio can be defined as either conventional sensors to nipple sensors or nipple sensors to conventional sensors. Accordingly, the array of sensors 100 of FIG. 1 may include a plurality of sensors as described according to FIGS. 2-3, as well as conventional sensors conventional sensors without a shroud and snorkel line, and may be arranged to alternate between the one and the other, any other combination or order along the line 110.

Moreover, although the sensors in FIGS. 1-3 are illustrated as coupled with a line (such as a TEC), the array of sensors may instead be simply coupled to the tubular or a collar without an intervening line between the sensors of the array.

As noted above, currently utilized lab setting/digital experiments for understanding such petrophysical properties neither enable anticipating/forecasting changes in physical properties for consideration within the reservoir simulation is not possible nor enable forecasting and planning of maintenance of existing sensors such as sensors 101 in wellbore 13. Hereinafter, methods for using a virtual sensor and machine learning based techniques to (1) determine/forecast changes in formation, petrophysical and hydraulic properties of the formation and (2) determine/forecast need for maintenance of physical sensors 101 will be described.

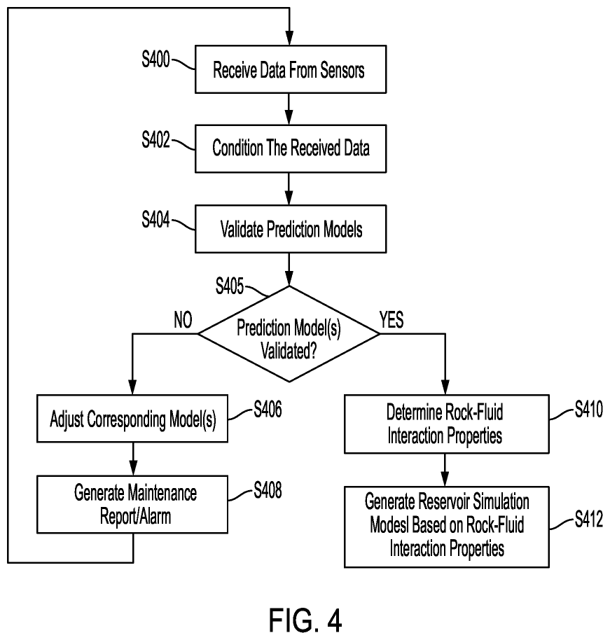

FIG. 4 is an example method of determining formation properties and maintenance of physical sensor using a virtual sensor, according to one aspect of the present disclosure. FIG. 4 will be described from perspective of device 200. However, it will be understood that device 200 has one or more associated processors configured to execute computer-readable instructions to perform functions described below with reference to FIG. 4.

At S400, device 200 receives data from sensors 101. As noted above such received data may include but is not limited to pressure, temperature and rate of fluid production at the completion depth as collected by sensors 101 shown in FIG. 1 and described above.

At S402, device 200 conditions the received data, where such conditioning can include performing various types of known or to be developed filtering on the data to remove noise, unwanted signal components, etc. Such conditioning can further include any type of known or to be developed fitting and extrapolation method to account for missing data, etc.

During exploration and production phases of wellbore 13, sensors 101 may continuously collect data such as temperature, pressure or flow rate. The collected data can be used to construct a predictive model where past collected data can be used to predict a present value of the same data. For example, pressure data collected in the past can be used to build a predictive model to predict a present value (e.g., at current time “t”) of pressure that is being collected by sensors 101. Similarly, past collected temperature data can be used to predict present value of temperature that is being collected by sensors 101 and past collected rate data can be used to predict present value of rate that is being collected by sensors 101.

In one example, as pressure, temperature and flow rate values may differ at different locations along wellbore 13 and that sensors 101 are located at such different locations, such predictive models can be sensor specific (e.g., a separate model for each sensor 101).

The underlying data required for predictive modeling can be constructed/generated in a laboratory setting and based on data collected by sensors 101 and received by device 200 at S400.

Referring back to FIG. 4, when data (e.g., pressure, temperature and/or flow rate data) is received at S400 and conditioned at S402, then at S404, device 200 validates the predictive models by comparing the received data to predicted values from the predictive models available to device 200. For example, device 200 compares received pressure at time “t” with a predicted pressure value at time “t” from the corresponding predictive model. Similarly, device 200 compares received temperature at time “t” with predicted temperature value at time “t” from the corresponding predictive model. Similarly, device 200 compares received rate at time “t” with predicted temperature value at time “t” from the corresponding predictive model. As noted, such comparison may be specific and different for each sensor 101 in wellbore 13.

At S405, device 200 determines whether received data is within a threshold value (where such threshold may be a configurable parameter determined based on experiments and/or empirical studies) of its corresponding predicted value from the corresponding predictive model. If not within the threshold value (which translated into the predictive model(s) not being validated), then at S406, the received data is used by device 200 to further adjust the corresponding model. For example, received data at S400 may include pressure and temperature readings by a given sensor 190 but not rate data. The comparison at S404 may indicate that the pressure reading is within a threshold of the predicted pressure value from the pressure specific predictive model but that the temperature reading is not within a threshold of the predicted temperature reading. Accordingly, at S406, device 200 may use the received temperature data at S400 to update the temperature predictive model but does not update the pressure predictive model as the pressure reading and the predicted pressure value are within the threshold of one another.

In one example, processes at S404, S405 and S406 as performed by device 200 may be referred to as virtual sensing and thus device 200 may operate as a virtual sensor.

Discrepancies greater than the threshold value may also be indicative of possible malfunctioning of corresponding physical sensors 101 within wellbore 13. Therefore, at S408, device 200 may generate a report/generate an alarm indicative of malfunctioning or need for updating/servicing the corresponding sensor(s) 101. Thereafter, the process reverts back to S400 and device 200 may repeat processes S400 to S408.

However, if at S405, device 200 determines that the received data is within the threshold value (predictive model(s) validated), then at S410, device 200 determines one or more rock-fluid interaction adjustment properties such as effective and relative permeability based on the data received at S400 and conditioned at S402.

As noted above, various samples may be extracted using known or to be developed tools such as those described above with reference to FIG. 1, from wellbore 13. These samples are then taken to a laboratory to be analyzed to determine various formation and rock-fluid interaction properties of rocks and soil samples. Various apparatuses and methods exist for testing an analyzing the core samples. One example apparatus is a centrifuge with a rotating arm to an end of which a sample holder and a vial is connected to determine fluid-rock interaction.

As these samples are extracted from wellbore 13, sensors 101 continuously collect pressure, temperature and/or flow rate data from wellbore 13. Accordingly, once such rock-fluid interaction properties are determined in a laboratory setting (using physical and digital experiments described above), the derived rock-fluid interaction properties such as absolute, effective and relative permeability may be associated with recorded pressure, temperature and/or flow rate records of sensors 101. Therefore, a machine learning model using various known or to be developed deep neural networks (DNNs) can be constructed to correlate recorded pressure, temperature and/or flow rate recordings with rock-fluid interaction properties such as absolute, effective and relative permeability.

In one example, a single model can be made for correlating all or some of the recorded variables to one or more rock-fluid interaction properties (e.g., pressure/temperature v. permeability, pressure/temperature/rate v. permeability, etc.). In another example, a separate machine learning model can be constructed to correlate each recorded variable (pressure, temperature or rate) to such rock-fluid interaction properties (e.g., pressure v. permeability, temperature v. permeability, rate v. v. permeability, etc.).

Therefore, at S410, device 200, using data received at S400 and conditioned at S402 determines one or more rock-fluid interaction adjustments to rock-fluid interaction properties of the completed formation in wellbore 13 by inputting the received data into the constructed machine learning model, which outputs the one or more values associated with the desired rock-fluid interaction properties. Thereafter, at S412, the determined rock-fluid interaction properties utilized for reservoir simulation which can be performed by device 200 and/or any other processing unit(s) configured for such simulation.

At S412, device 200 inputs the one or more rock-fluid interaction properties into a reservoir simulation model for modeling wellbore 101 (generating reservoir simulation model for wellbore 101) and assessing hydrocarbon production potentials and feasibility of wellbore 101.

Thereafter, the process reverts back to S400 and device 200 may repeat processes S400 to S410.

Example embodiments described above provide numerous improvements of physical sensors installed within wellbores to estimate petrophysical properties such as relative permeability and capillary pressure using mathematical models and DNNs and data collected by such physical sensors (e.g., pressure, temperature, rate of fluid production, etc.). This eliminates the need for installing specialized hardware and sensors inside wellbores for purposes of determining and estimating changes in such rock-fluid interaction properties. Furthermore, example embodiments described above can be utilized for predictive maintenance and troubleshooting of existing physical sensors related to such sensors' completion, piping, tubing, casing, etc. These advantages help reduce costs associated with evaluating formation properties during production and updating reservoir simulation models with concurrent information regarding the description of rock-fluid interaction in the formation.

The disclosure now turns to various components and system architectures that can be utilized as device 200 to implement the functionalities described above.

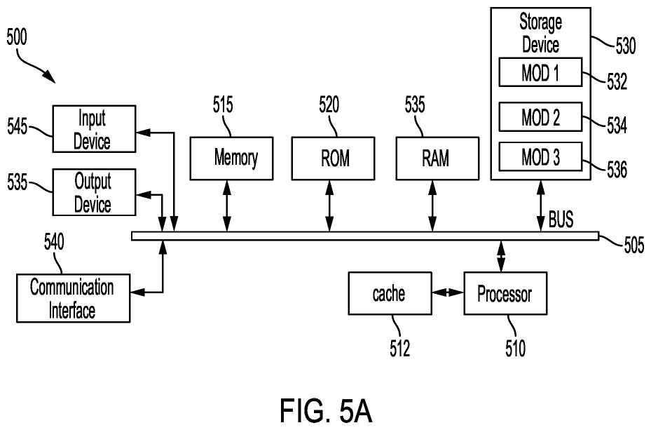

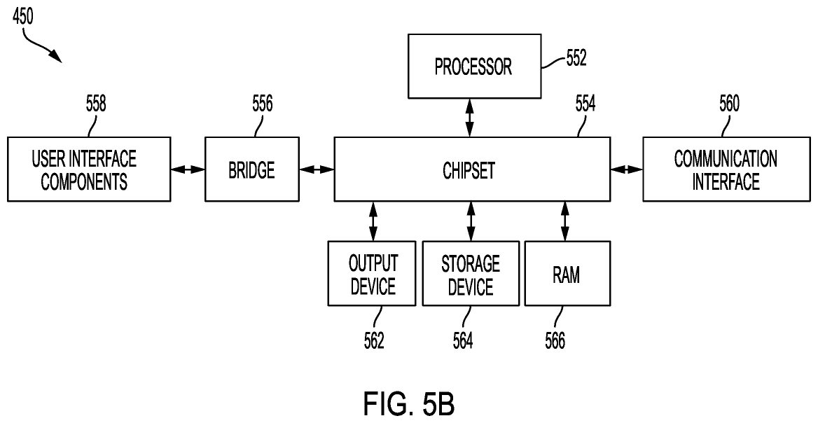

FIGS. 5A-B illustrates schematic diagram of example computing device and system according to one aspect of the present disclosure. FIG. 5A illustrates a computing device which can be employed to perform various steps, methods, and techniques disclosed above. The more appropriate embodiment will be apparent to those of ordinary skill in the art when practicing the present technology. Persons of ordinary skill in the art will also readily appreciate that other system embodiments are possible.

Example system and/or computing device 500 includes a processing unit (CPU or processor) 510 and a system bus 505 that couples various system components including the system memory 515 such as read only memory (ROM) 520 and random access memory (RAM) 535 to the processor 510. The processors disclosed herein can all be forms of this processor 510. The system 500 can include a cache 512 of high-speed memory connected directly with, in close proximity to, or integrated as part of the processor 510. The system 500 copies data from the memory 515 and/or the storage device 530 to the cache 512 for quick access by the processor 510. In this way, the cache provides a performance boost that avoids processor 510 delays while waiting for data. These and other modules can control or be configured to control the processor 510 to perform various operations or actions. Other system memory 515 may be available for use as well. The memory 515 can include multiple different types of memory with different performance characteristics. It can be appreciated that the disclosure may operate on a computing device 500 with more than one processor 510 or on a group or cluster of computing devices networked together to provide greater processing capability. The processor 510 can include any general purpose processor and a hardware module or software module (service), such as module 1 532, module 2 534, and module 3 536 stored in storage device 530, configured to control the processor 510 as well as a special-purpose processor where software instructions are incorporated into the processor. The processor 510 may be a self-contained computing system, containing multiple cores or processors, a bus, memory controller, cache, etc. A multi-core processor may be symmetric or asymmetric. The processor 510 can include multiple processors, such as a system having multiple, physically separate processors in different sockets, or a system having multiple processor cores on a single physical chip. Similarly, the processor 510 can include multiple distributed processors located in multiple separate computing devices, but working together such as via a communications network. Multiple processors or processor cores can share resources such as memory 515 or the cache 512, or can operate using independent resources. The processor 510 can include one or more of a state machine, an application specific integrated circuit (ASIC), or a programmable gate array (PGA) including a field PGA (FPGA).

The system bus 505 may be any of several types of bus structures including a memory bus or memory controller, a peripheral bus, and a local bus using any of a variety of bus architectures. A basic input/output (BIOS) stored in ROM 520 or the like, may provide the basic routine that helps to transfer information between elements within the computing device 500, such as during start-up. The computing device 500 further includes storage devices 530 or computer-readable storage media such as a hard disk drive, a magnetic disk drive, an optical disk drive, tape drive, solid-state drive, RAM drive, removable storage devices, a redundant array of inexpensive disks (RAID), hybrid storage device, or the like. The storage device 530 can include software modules 532, 534, 536 for controlling the processor 510. The system 500 can include other hardware or software modules. The storage device 530 is connected to the system bus 505 by a drive interface. The drives and the associated computer-readable storage devices provide nonvolatile storage of computer-readable instructions, data structures, program modules and other data for the computing device 500. In one aspect, a hardware module that performs a particular function includes the software component stored in a tangible computer-readable storage device in connection with the necessary hardware components, such as the processor 510, bus 505, and so forth, to carry out a particular function. In another aspect, the system can use a processor and computer-readable storage device to store instructions which, when executed by the processor, cause the processor to perform operations, a method or other specific actions. The basic components and appropriate variations can be modified depending on the type of device, such as whether the device 500 is a small, handheld computing device, a desktop computer, or a computer server. When the processor 510 executes instructions to perform “operations”, the processor 510 can perform the operations directly and/or facilitate, direct, or cooperate with another device or component to perform the operations.

Although the exemplary embodiment(s) described herein employs the hard disk 530, other types of computer-readable storage devices which can store data that are accessible by a computer, such as magnetic cassettes, flash memory cards, digital versatile disks (DVDs), cartridges, random access memories (RAMs) 535, read only memory (ROM) 520, a cable containing a bit stream and the like, may also be used in the exemplary operating environment. Tangible computer-readable storage media, computer-readable storage devices, or computer-readable memory devices, expressly exclude media such as transitory waves, energy, carrier signals, electromagnetic waves, and signals per se.

To enable user interaction with the computing device 500, an input device 545 represents any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art. In some instances, multimodal systems enable a user to provide multiple types of input to communicate with the computing device 500. The communications interface 540 generally governs and manages the user input and system output. There is no restriction on operating on any particular hardware arrangement and therefore the basic hardware depicted may easily be substituted for improved hardware or firmware arrangements as they are developed.

For clarity of explanation, the illustrative system embodiment is presented as including individual functional blocks including functional blocks labeled as a “processor” or processor 510. The functions these blocks represent may be provided through the use of either shared or dedicated hardware, including, but not limited to, hardware capable of executing software and hardware, such as a processor 510, that is purpose-built to operate as an equivalent to software executing on a general purpose processor. For example the functions of one or more processors presented in FIG. 6A may be provided by a single shared processor or multiple processors. (Use of the term “processor” should not be construed to refer exclusively to hardware capable of executing software.) Illustrative embodiments may include microprocessor and/or digital signal processor (DSP) hardware, read-only memory (ROM) 520 for storing software performing the operations described below, and random access memory (RAM) 535 for storing results. Very large scale integration (VLSI) hardware embodiments, as well as custom VLSI circuitry in combination with a general purpose DSP circuit, may also be provided.

The logical operations of the various embodiments are implemented as: (1) a sequence of computer implemented steps, operations, or procedures running on a programmable circuit within a general use computer, (2) a sequence of computer implemented steps, operations, or procedures running on a specific-use programmable circuit; and/or (3) interconnected machine modules or program engines within the programmable circuits. The system 500 shown in FIG. 5A can practice all or part of the recited methods, can be a part of the recited systems, and/or can operate according to instructions in the recited tangible computer-readable storage devices. Such logical operations can be implemented as modules configured to control the processor 510 to perform particular functions according to the programming of the module. For example, FIG. 6A illustrates three modules Mod1 532, Mod2 534 and Mod3 536 which are modules configured to control the processor 510. These modules may be stored on the storage device 530 and loaded into RAM 535 or memory 515 at runtime or may be stored in other computer-readable memory locations.

One or more parts of the example computing device 500, up to and including the entire computing device 500, can be virtualized. For example, a virtual processor can be a software object that executes according to a particular instruction set, even when a physical processor of the same type as the virtual processor is unavailable. A virtualization layer or a virtual “host” can enable virtualized components of one or more different computing devices or device types by translating virtualized operations to actual operations. Ultimately however, virtualized hardware of every type is implemented or executed by some underlying physical hardware. Thus, a virtualization compute layer can operate on top of a physical compute layer. The virtualization compute layer can include one or more of a virtual machine, an overlay network, a hypervisor, virtual switching, and any other virtualization application.

The processor 510 can include all types of processors disclosed herein, including a virtual processor. However, when referring to a virtual processor, the processor 510 includes the software components associated with executing the virtual processor in a virtualization layer and underlying hardware necessary to execute the virtualization layer. The system 500 can include a physical or virtual processor 510 that receive instructions stored in a computer-readable storage device, which cause the processor 510 to perform certain operations. When referring to a virtual processor 510, the system also includes the underlying physical hardware executing the virtual processor 510.

FIG. 5B illustrates an example computer system 550 having a chipset architecture that can be used in executing the described method and generating and displaying a graphical user interface (GUI). Computer system 550 is an example of computer hardware, software, and firmware that can be used to implement the disclosed technology. System 550 can include a processor 552, representative of any number of physically and/or logically distinct resources capable of executing software, firmware, and hardware configured to perform identified computations. Processor 552 can communicate with a chipset 554 that can control input to and output from processor 552. In this example, chipset 554 outputs information to output device 562, such as a display, and can read and write information to storage device 564, which can include magnetic media, and solid state media, for example. Chipset 554 can also read data from and write data to RAM 566. A bridge 556 for interfacing with a variety of user interface components 585 can be provided for interfacing with chipset 554. Such user interface components 585 can include a keyboard, a microphone, touch detection and processing circuitry, a pointing device, such as a mouse, and so on. In general, inputs to system 550 can come from any of a variety of sources, machine generated and/or human generated.

Chipset 554 can also interface with one or more communication interfaces 560 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 552 analyzing data stored in storage 564 or 566. Further, the machine can receive inputs from a user via user interface components 585 and execute appropriate functions, such as browsing functions by interpreting these inputs using processor 552.

It can be appreciated that example systems 500 and 550 can have more than one processor 510/552 or be part of a group or cluster of computing devices networked together to provide greater processing capability.

Embodiments within the scope of the present disclosure may also include tangible and/or non-transitory computer-readable storage devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### STATEMENTS OF THE DISCLOSURE INCLUDE

Statement 1: A method includes receiving data from one or more physical sensors within a well; determining at least one formation property of the well using one or more machine learning models receiving the data as input and generating reservoir simulation models using the at least one formation property.

Statement 2: The method of statement 1, wherein the data includes one or more of a temperature, pressure or flow rate of fluid transfer from the formation to the wellbore as measured by the one or more physical sensors.

Statement 3: The method of statement 1, wherein the one or more physical sensors are installed inside the wellbore.

Statement 4: The method of statement 1, further including detecting a faulty behavior of any one of the one or more physical sensors based on comparing the data with one or more corresponding machine learning based predictive models.

Statement 5: The method of statement 4, further including retraining the one or more corresponding machine learning based predictive models upon detecting the faulty behavior.

Statement 6: The method of statement 4, further including communicating the faulty behavior to a control center associated with the wellbore.

Statement 7: The method of statement 1, wherein the at least one formation property is relative permeability within a zone of interest inside the wellbore.

Statement 8: The method of statement 1, wherein the at least one formation property is effective permeability within a zone of interest inside the wellbore.

Statement 9: A device including one or more memories having computer-readable instructions stored therein; and one or more processors configured to execute the computer-readable instructions to receive data from one or more physical sensors within a wellbore; determine at least one formation property of the wellbore using one or more machine learning models receiving the data as input; and generate reservoir simulation models using the at least one formation property.

Statement 10: The device of statement 9, wherein the data includes one or more of a temperature, pressure or rate of fluid interaction within the wellbore as measured by the one or more physical sensors.

Statement 11: The device of statement 9, wherein the one or more physical sensors are installed inside the wellbore.

Statement 12: The device of statement 9, wherein the one or more processors are further configured to execute the computer readable instructions to detect a faulty behavior of any one of the one or more physical sensors based on comparing the data with one or more corresponding machine learning based predictive models.

Statement 13: The device of statement 12, wherein the one or more processors are further configured to execute the computer readable instructions to retain the one or more corresponding machine learning based predictive models upon detecting the faulty behavior.

Statement 14: The device of statement 12, wherein the one or more processors are further configured to execute the computer readable instructions to communicate the faulty behavior to a control center associated with the wellbore.

Statement 15: The device of statement 9, wherein the at least one formation property is relative or effective permeability within a zone of interest inside the wellbore.

Statement 16: The device of statement 9, wherein the at least one formation property is effective permeability within a zone of interest inside the wellbore.

Statement 17: One or more non-transitory computer-readable media comprising computer-readable instructions, which when executed by one or more processors, cause the one or more processors to receive data from one or more physical sensors within a wellbore; determine at least one formation property of the wellbore using one or more machine learning models receiving the data as input; and generate reservoir simulation models using the at least one formation property.

Statement 18: The one or more non-transitory computer-readable media of statement 17, wherein the data includes one or more of a temperature, pressure or flow rate of fluid transfer from the formation to the wellbore as measured by the one or more physical sensors; and the at least one formation property is relative permeability within a zone of interest inside the wellbore.

Statement 19: The one or more non-transitory computer-readable media of statement 17, wherein the one or more physical sensors are installed inside the wellbore.

Statement 20: The one or more non-transitory computer-readable media of statement 17, wherein the execution of the computer-readable instructions by the one or more processors further cause the one or more processors to detect a faulty behavior of any one of the one or more physical sensors based on comparing the data with one or more corresponding machine learning based predictive models.

Statement 21: The one or more non-transitory computer-readable media of statement 20, wherein the execution of the computer-readable instructions by the one or more processors further cause the one or more processors to retain the one or more corresponding machine learning based predictive models upon detecting the faulty behavior.

Statement 21: The one or more non-transitory computer-readable media of statement 20, wherein the execution of the computer-readable instructions by the one or more processors further cause the one or more processors to communicate the faulty behavior to a control center associated with the wellbore.

Statement 22: The one or more non-transitory computer-readable media of statement 20, wherein the execution of the computer-readable instructions by the one or more processors further cause the one or more processors to communicate the faulty behavior to a control center associated with the wellbore.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. Rather, the described features and steps are disclosed as possible components of systems and methods within the scope of the appended claims.

What is claimed is:

1. A method comprising:
receiving data from one or more physical sensors within a wellbore;
determining at least one formation property of the wellbore using one or more machine learning models receiving the data as input; and
generating reservoir simulation models using the at least one formation property.

2. The method of claim 1, wherein the data includes one or more of a formation temperature, pressure or rate of fluid transfer from the formation to the well as measured by the one or more physical sensors.

3. The method of claim 1, wherein the one or more physical sensors are installed inside the wellbore.

4. The method of claim 1, further comprising:
detecting a faulty behavior of any one of the one or more physical sensors based on comparing the data with one or more corresponding machine learning based predictive models.

5. The method of claim 4, further comprising:
retraining the one or more corresponding machine learning based predictive models upon detecting the faulty behavior.

6. The method of claim 4, further comprising:
communicating the faulty behavior to a control center associated with the wellbore.

7. The method of claim 1, wherein the at least one formation property is relative permeability within a zone of interest inside the wellbore.

8. The method of claim 1, wherein the at least one formation property is effective permeability within a zone of interest inside the wellbore.

9. A device comprising
one or more memories having computer-readable instructions stored therein; and
one or more processors configured to execute the computer-readable instructions to:
receive data from one or more physical sensors within a wellbore;
determine at least one formation property of the wellbore using one or more machine learning models receiving the data as input; and
generate reservoir simulation models using the at least one formation property.

10. The device of claim 9, wherein the data includes one or more of a formation temperature, pressure or rate of fluid transfer from the formation to the well as measured by the one or more physical sensors.

11. The device of claim 9, wherein the one or more physical sensors are installed inside the wellbore.

12. The device of claim 9, wherein the one or more processors are further configured to execute the computer readable instructions to detect a faulty behavior of any one of the one or more physical sensors based on comparing the data with one or more corresponding machine learning based predictive models.

13. The device of claim 12, wherein the one or more processors are further configured to execute the computer readable instructions to retain the one or more corresponding machine learning based predictive models upon detecting the faulty behavior.

14. The device of claim 12, wherein the one or more processors are further configured to execute the computer readable instructions to communicate the faulty behavior to a control center associated with the wellbore.

15. The device of claim 9, wherein the at least one formation property is relative permeability within a zone of interest inside the wellbore.

16. The device of claim 9, wherein the at least one formation property is effective permeability within a zone of interest inside the wellbore.

17. One or more non-transitory computer-readable media comprising computer-readable instructions, which when executed by one or more processors, cause the one or more processors to:
receive data from one or more physical sensors within a wellbore;
determine at least one formation property of the wellbore using one or more machine learning models receiving the data as input; and
generate reservoir simulation models using the at least one formation property.

18. The one or more non-transitory computer-readable media of claim 17, wherein
the data includes one or more of a formation temperature, pressure or rate of fluid transfer from the formation to the wellbore as measured by the one or more physical sensors; and
the at least one formation property is effective permeability within a zone of interest inside the wellbore.

19. The one or more non-transitory computer-readable media of claim 17, wherein the one or more physical sensors are installed inside the wellbore.

20. The one or more non-transitory computer-readable media of claim 17, wherein the execution of the computer-readable instructions by the one or more processors further cause the one or more processors to detect a faulty behavior of any one of the one or more physical sensors based on comparing the data with one or more corresponding machine learning based predictive models.

21-22. (canceled)
